(19) United States
(12) Patent Application Publication
(10) Pub. No.: US 2017/0209321 A1
(43) Pub. Date: Jul. 27, 2017

(54) Electric Bed Frame

(71) Applicant: Chuan-Hang SHIH, Lu-Kang Town (TW)

(72) Inventor: Chuan-Hang SHIH, Lu-Kang Town (TW)

(21) Appl. No.: 15/065,482

(22) Filed: Mar. 9, 2016

(30) Foreign Application Priority Data
Jan. 21, 2016 (TW) 105200899

(51) Int. Cl. A61G 7/018; A61G 7/015

(52) U.S. Cl. CPC A61G 7/018; A61G 7/015

(57) ABSTRACT

An electric bed frame includes a fixed rack, a movable rack rotatably connected with the fixed rack, an actuator rotatably connected with the fixed and movable racks and including a cylinder and a push lever movable into and out of the cylinder, and a supporting board disposed on the movable rack and having a hollow portion accommodating a part of the actuator. When the push lever is moved out of the cylinder to make the actuator lengthened, the movable rack is swung upwardly relative to the fixed rack. When the push lever is moved into the cylinder to make the actuator shortened, the movable rack is swung downwardly relative to the fixed rack. As a result, the electric bed frame is thin and can be placed on the traditional bed without heightening the mattress too much, so that the user can get on and off bed conveniently.

### BACKGROUND OF THE INVENTION

1. Field of the Invention

The present invention relates generally to bed frames and more particularly, to an electric bed frame.

2. Description of the Related Art

A conventional electric bed, which includes an electric bed frame, a foot frame and a mattress, can lift the back or the legs of the user, and the form of the electric bed is adjustable according to the personal demands of the consumer so that the consumer can rest on the electric bed in the most comfortable form for the consumer for physical and emotional relaxation. However, some consumers may be unwilling to buy the electric bed because they think it's wasteful to buy a whole new electric bed on the condition that there has been a normal bed at home for rest and sleep, thereby sacrificing the chance to rest and relax well. Therefore, it is an objective for the dealers in the industry to provide an electric bed frame which can be used in coordination with the traditional bed.

### SUMMARY OF THE INVENTION

The present invention has been accomplished in view of the above-noted circumstances. It is an objective of the present invention to provide an electric bed frame which can be used in coordination with the traditional bed for performing the lifting and lowering effect like the electric bed on the traditional bed. It is another objective of the present invention to provide an electric bed frame which is thin, suitable to be placed between a normal bed frame and a mattress or on the ground for usage, and convenient for the consumer to get on the bed and get off bed.

To attain the above objective, the present invention provides an electric bed frame which includes a fixed rack, a movable rack, an actuator, and a supporting board. The movable rack is rotatably connected with the fixed rack. Two ends of the actuator are rotatably connected with the fixed rack and the movable rack respectively. The actuator includes a cylinder and a push lever extended from the cylinder and movable into and out of the cylinder. When the push lever is moved out of the cylinder to make the actuator lengthened, the movable rack is swung upwardly relative to the fixed rack. When the push lever is moved into the cylinder to make the actuator shortened, the movable rack is swung downwardly relative to the fixed rack. The supporting board is disposed on a top side of the movable rack and has a hollow portion accommodating a part of the actuator.

Because the actuator is partially accommodated in the hollow portion of the supporting board, the electric bed frame can be lowered in thickness and placed between the normal bed frame and the mattress or on the ground for usage, thereby convenient for the consumer to get on the bed and get off bed.

### BRIEF DESCRIPTION OF THE DRAWINGS

FIG. 1 is a perspective view of an electric bed frame according to a preferred embodiment of the present invention.

FIG. 2 is a sectional view of a part of the electric bed frame according to the preferred embodiment of the present invention.

FIG. 3 is another perspective view of the electric bed frame according to the preferred embodiment of the present invention, showing the function of the electric bed frame.

### DETAILED DESCRIPTION OF THE INVENTION

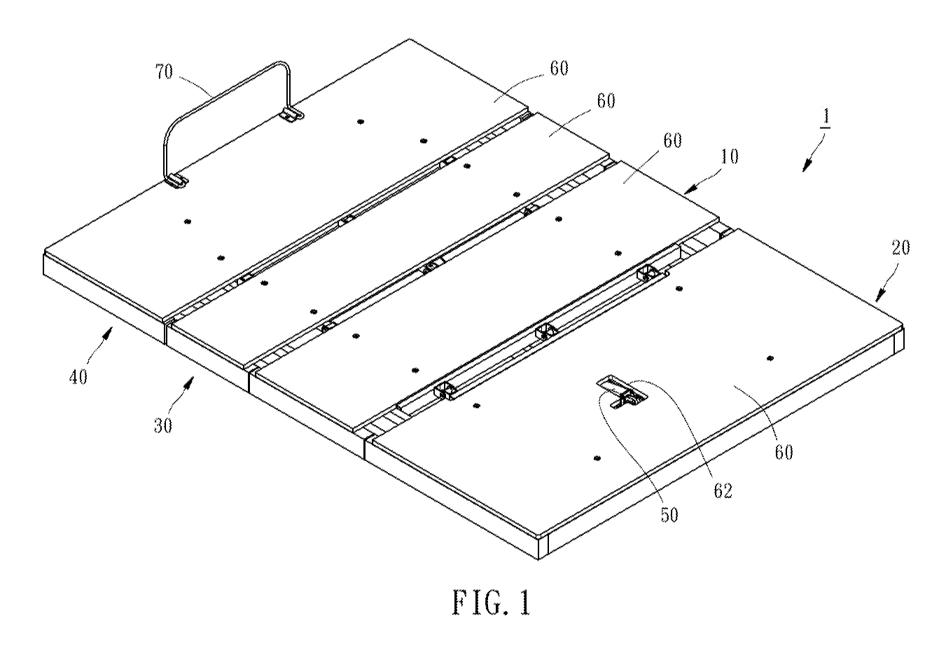

Referring to FIG. 1, an electric bed frame 1 according to a preferred embodiment of the present invention includes a fixed rack 10, a movable rack 20, a thigh rack 30, a shank rack 40, an actuator 50, four supporting boards 60, and a bracket 70. The electric bed frame 1 is adapted for a mattress (not shown) to be placed thereon.

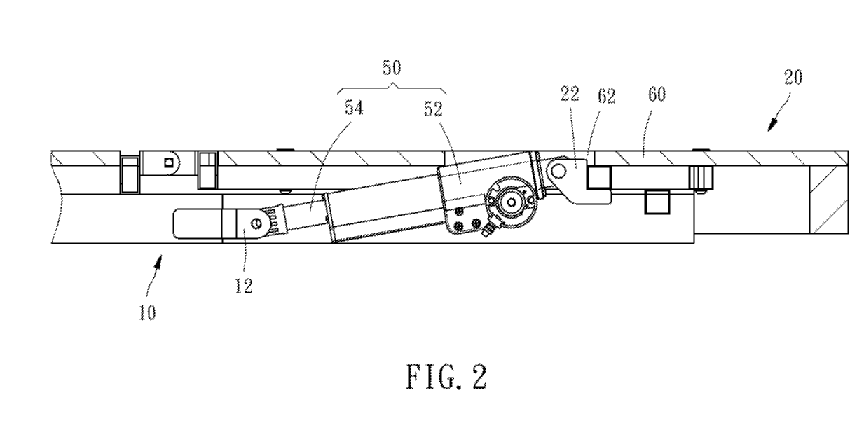

The fixed rack 10 is located correspondingly to the hips of the user and kept stationary. The fixed rack 10 has a connecting portion 12; an end of the actuator 50 is rotatably connected with the connecting portion 12, as shown in FIG. 2.

The movable rack 20 is rotatably connected with the fixed rack 10, which means the movable rack 20 can be swung relative to the fixed rack 10. The movable rack 20 has a connecting portion 22 rotatably connected with the other end of the actuator 50. In this embodiment, the movable rack 20 is located correspondingly to the back of the user.

The thigh rack 30 and the shank rack 40 in this embodiment are kept stationary. However, in other embodiments, the thigh rack 30 may be swingable relative to the fixed rack 10, and the shank rack 40 may be swingable relative to the thigh rack 30.

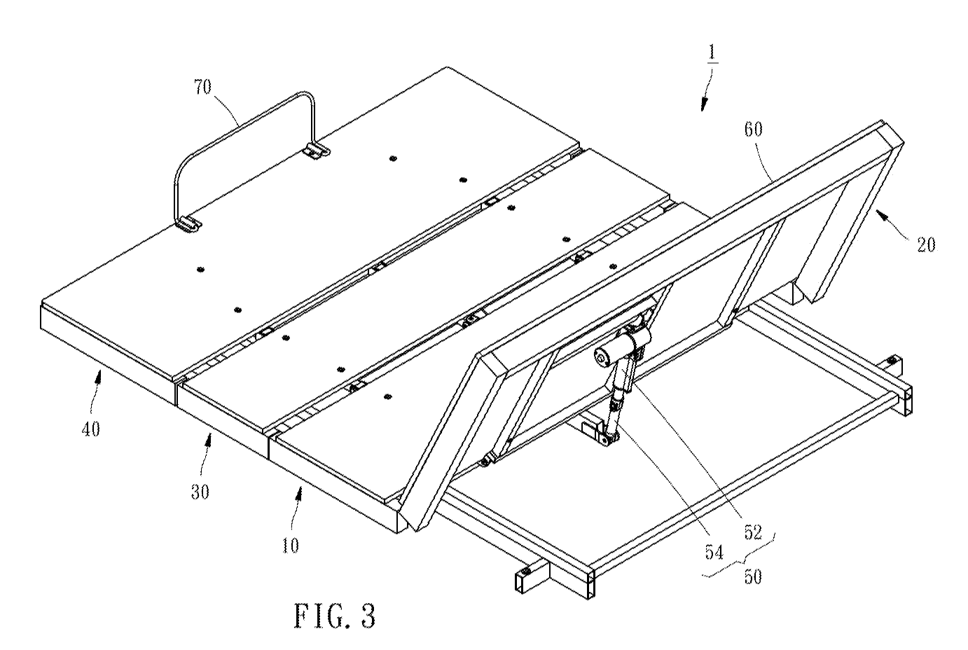

The actuator 50, two ends of which are rotatably connected with the fixed rack 10 and the movable rack 20 respectively, includes a cylinder 52 and a push lever 54 extended from the cylinder 52 and movable into and out of the cylinder 52. In this embodiment, the cylinder 52 of the actuator 50 is rotatably connected with the connecting portion 22 of the movable rack 20, and the push lever 54 of the actuator 50 is rotatably connected with the connecting portion 12 of the fixed rack 10. When the push lever 54 is moved out of the cylinder 52 to make the actuator 50 lengthened, the actuator 50 drives the movable rack 20 to swing upwardly relative to the fixed rack 10, as shown in FIG. 3. The movable rack 20 stops swinging upwardly when the push lever 54 is extended from the cylinder 52 for the longest length. When the push lever 54 is moved into the cylinder 52 to make the actuator 50 shortened, the actuator 50 drives the movable rack 20 to swing downwardly relative to the fixed rack 10. The movable rack 20 stops swinging downwardly when the movable rack 20 is located as shown in FIG. 1.

The four supporting boards 60 are disposed on the top sides of the fixed rack 10, the movable rack 20, the thigh rack 30 and the shank rack 40 respectively. The supporting board 60 disposed on the top side of the movable rack 20 is penetrated with a hollow portion 62 which accommodates a part of the actuator 50 and a part of the connecting portion 22 of the movable rack 20. In this embodiment, the cylinder 52 of the actuator 50 is partially accommodated in the hollow portion 62. Besides, it can be observed in FIG. 2 that the actuator 50 and the connecting portion 22 are not protruded out of the hollow portion 62.

The bracket 70 is disposed on the supporting board 60 located at the foot portion of the bed for preventing the mattress from displacing. In this embodiment, the aforesaid supporting board 60 where the bracket 70 is disposed is located at the top side of the shank rack 40. In other embodiments, the bracket 70 may be disposed on other supporting boards 60, and the electric bed frame may even include two or more brackets 70.

In fact, the supporting board 60 is so thick to have enough structural strength to bear the weights of the mattress and the user, so the hollow portion 62 has enough space to accommodate parts of the actuator 50 and the connecting portion 22. Because there is the hollow portion 62, the position where the actuator 50 and the connecting portion 22 are rotatably connected with each other can be raised to provide the actuator 50 enough height difference between two ends thereof, so that the actuator 50 is long enough in lever arm for providing the torque to rotate the movable rack 20. As a result, the electric bed frame 1 can be lowered in thickness. When being used in coordination with the traditional bed, the quite thin electric bed frame 1 can lower the user's feeling of unfamiliarity. No matter the electric bed frame 1 is placed between the normal bed frame and the mattress or between the ground and the mattress, it can perform the lifting and lowering effect electrically, and is convenient for the user to get on the bed and get off bed, thereby excellent in safety, convenience and comfortableness.

Based on the spirit of the present invention, the structure of the electric bed frame 1 can be modified. For example, the actuator 50 can be installed in reverse direction, which means the push lever 54 of the actuator 50 is rotatably connected with the movable rack 20 and the cylinder 52 of the actuator 50 is rotatably connected with the fixed rack 10. However, in such condition the size and the shape of the hollow portion 62 should be modified correspondingly. Alternately, the connecting portion 22 of the movable rack 20 may not be accommodated in the hollow portion 62. In the aforesaid embodiment, the movable rack 20 is the back rack of the electric bed frame 1. However, the structural features of the present invention can be applied to the thigh rack 30 or the shank rack 40, which means the movable rack defined in the present invention may be the thigh rack or the shank rack of the electric bed frame.

The above description represents merely the preferred embodiment of the present invention, without any intention to limit the scope of the present invention. The simple variations and modifications not to be regarded as a departure from the spirit of the invention are intended to be included within the scope of the following claims.

What is claimed is:

1. An electric bed frame comprising:
a fixed rack;
a movable rack rotatably connected with the fixed rack;
an actuator, two ends of which are rotatably connected with the fixed rack and the movable rack respectively, the actuator comprising a cylinder and a push lever extended from the cylinder and movable into and out of the cylinder, the movable rack being swung upwardly relative to the fixed rack when the push lever is moved out of the cylinder to make the actuator lengthened, the movable rack being swung downwardly relative to the fixed rack when the push lever is moved into the cylinder to make the actuator shortened; and
a supporting board disposed on a top side of the movable rack and having a hollow portion accommodating a part of the actuator.

2. The electric bed frame as claimed in claim 1, wherein the cylinder of the actuator is rotatably connected with the movable rack, and the push lever of the actuator is rotatably connected with the fixed rack.

3. The electric bed frame as claimed in claim 2, wherein the movable rack has a connecting portion rotatably connected with one of the two ends of the actuator and partially located in the hollow portion of the supporting board.

4. The electric bed frame as claimed in claim 1, wherein the push lever of the actuator is rotatably connected with the movable rack, and the cylinder of the actuator is rotatably connected with the fixed rack.

5. The electric bed frame as claimed in claim 4, wherein the movable rack has a connecting portion rotatably connected with one of the two ends of the actuator and partially located in the hollow portion of the supporting board.

6. The electric bed frame as claimed in claim 1, wherein the movable rack has a connecting portion rotatably connected with one of the two ends of the actuator and partially located in the hollow portion of the supporting board.
